(19) United States
(12) Patent Application Publication
(10) Pub. No.: US 2024/0258634 A1
(43) Pub. Date: Aug. 1, 2024

(54) Battery Pack

(71) Applicant: SenergyK Innovative Creations Inc., Saskatoon (CA)

(72) Inventors: Soheil Akbari, Saskatoon (CA); Chad Roth, Saskatoon (CA)

(21) Appl. No.: 18/426,648

(22) Filed: Jan. 30, 2024

Related U.S. Application Data
(60) Provisional application No. 63/482,220, filed on Jan. 30, 2023.

(51) Int. Cl. H01M 50/291; H01M 10/625; H01M 10/647; H01M 10/6563; H01M 10/658; H01M 50/209; H01M 50/231; H01M 50/249; H01M 50/264; B60L 50/64

(52) U.S. Cl. CPC H01M 50/291; H01M 10/625; H01M 10/647; H01M 10/6563; H01M 10/658; H01M 50/209; H01M 50/231; H01M 50/249; H01M 50/264; B60L 50/64; H01M 2220/20

(57) ABSTRACT

A fully serviceable battery pack architecture can be serviced down to the cell level in a convenient and timely manner without needing to remove the complete battery pack from the vehicle or perform an extensive amount of labor. Such architecture is considered a special cell to pack technology that the cells are held in place by a compressive force providing static friction. The design of the tensioning mechanism allows for such tension to be released and reapplied by a technician using basic tools. A fan circulates the air inside the battery pack in a closed loop through a heat exchanger containing another fluid providing heating and cooling to the pack. Extensive insulation work and minimizing thermal bridging with the environment allows for superior performance, minimizing seasonal range inconsistency, improved efficiency and longevity of such pack in harsh climates where exposure to extreme cold or heat can affect the battery system adversely.

This application claims the benefit under 35 U.S.C. 119(e) of U.S. provisional application Ser. No. 63/482,220 filed Jan. 30, 2023.

### FIELD OF THE INVENTION

The present invention relates generally to a battery energy storage system, which may alternatively be referred to as a battery pack, and more particularly to such a battery energy storage system which (i) is configured to permit individual ones of the cells to be removed from a housing of the system independently of other cells; (ii) includes a thermal conditioning unit to regulate temperature of the battery pack; and (iii) is mounted to an external supporting bracket in a manner reducing thermal bridging. The original design is particularly but not exclusively suited for E-Mobility applications.

### BACKGROUND OF THE INVENTION

The capacity of a battery pack when fully charged is limited by the individual cell or module with the least capacity in the series, analogous to how a chain is only as strong as its weakest link. Typical high voltage battery packs found in electrified vehicles are using tens or hundreds of cells or modules in series to reach high enough voltages to provide or assist the vehicle with efficient traction. Failure or unexpected degradation of a certain cell or module can reduce the overall capacity of the entire battery pack or completely render it out of balance and useless. On the other hand, replacing a degraded cell with a brand-new cell in a partially aged pack is not a problem. The new cell will not fully charge or discharge like partially aged cells and only provides the same capacity as other cells can do. Therefore, a battery pack that is fully serviceable so that any cell can be replaced has an advantage in maximizing the lifespan and preventing defects. Research shows the vast majority of cells in an unbalanced and useless battery pack in current automotive applications are completely usable and have significant life left in them, but due to the non-serviceable nature of current designs they face a significantly shorter life span. This becomes a critical measure for medium and heavy-duty E-Mobility sector where the cost of the packs and expected service lifetime are significantly higher than passenger and light duty vehicles.

A vital criterion for battery pack longevity is temperature control. Battery cells have a fairly tight optimal operating temperature band, typically room temperature plus or minus a few degrees. Operation (charging or discharging) above or below this temperature band will compromise efficiency and accelerate aging of battery cells. In addition, battery cells generate heat during operation which can drive the temperature above the optimal band, and if left unchecked can also lead to catastrophic failure. Considering the high costs associated with battery packs in electrified vehicles (pure battery electric, plugin hybrid, or hydrogen fuel cell) maximizing the efficiency and longevity of the battery pack system is critical. This can be achieved by providing heating or cooling, depending on thermal conditions surrounding the battery pack, to maintain the optimal temperature during operation.

On an electrified vehicle, battery cells are secured in place and protected from the elements. This can be done by securing them in an enclosure. Operation of battery cells in an enclosure on a vehicle presents the challenge of thermal management. The battery cells may require heating or cooling, depending on a variety of factors including the ambient conditions, the amount of heat being generated by the battery cells themselves, and the thermal characteristics and geometry of the enclosure. Considering major variation of outdoor temperatures in different climates, and the tight optimal temperature band for a battery pack, the required thermal management for an optimal efficiency in all seasons can be very complicated. If the vehicle is designed to operate in a rather temperate climate, or a temperature-controlled environment, the battery pack may be able to rely on passive cooling from ambient air. Otherwise, insulation may be used to provide more consistent conditions for the battery cells regardless of outside ambient conditions, however this prevents passive cooling when outside conditions are favorable. Considering all season operation as a necessity, there are a wide range of boundary conditions to be satisfied and having significant insulation involved becomes a necessity.

A battery energy storage system suitable for any climate is configured to maintain a constant temperature regardless of outside conditions. This may be done through a thermal management system, which may monitor the temperature of the battery cells and deliver heating or cooling depending on the present requirements. This may be done through heat exchange with a circulating fluid in thermal contact with the battery cells, which has its temperature controlled by external sources of heating or cooling. Heating or cooling may be sourced from a variety of places including, but not limited to the ambient environment, waste heat from other components on the vehicle such as the motor and electronics, and a refrigeration or heat pump cycle.

Range loss observed in winter conditions is mainly driven by A) reduced efficiency of battery packs with temperature and B) increased heat requirements of cabin. A well-designed battery pack capable of 1) an effective thermal insulation and 2) uniform distribution of cooling and heating energy between cells resulting in a uniform temperature across the pack can significantly help with “A) reduced efficiency of battery packs with temperature”.

### SUMMARY OF THE INVENTION

According to an aspect of the invention, there is provided a battery pack that contains a plurality of cells, that may be of any form factor, meaning of any three dimensional shape, arranged in a plurality of rows. There are spaces between the cells, ranging from 1 to 5 millimeters, that allow air to flow between cells and therefore provide heat exchange between the air and the cells. Preferably, the spacing is optimized for an even temperature distribution among different cells. The air flow is generated by a fan or blower, preferably with variable speed to improve efficiency since the heating and cooling demands are varied. The geometry of the enclosure is such that the air flows in a closed loop through the rows of cells and then through a heat exchanger. The air in the battery pack remains completely sealed from the environment except a membrane based breathing device that allows only exchange of air to keep pressure balanced and blocks moisture from entering. Preferably, a desiccant packet is contained somewhere within the inside air volume to prevent condensation from occurring, which is replaceable whenever the battery pack is serviced.

According to another aspect of the invention, the air inside the battery pack is heated or cooled through heat exchange with another fluid. This other fluid may be part of a thermal management system that monitors the temperature of the air and/or the cells in the battery pack, and provides heating or cooling as needed from a source external to the battery pack.

According to yet another aspect of the invention, the cells are held in place by a tensioning mechanism providing axial compression force to the rows of cells. The compression force on each cell is calculated and designed to be high enough to create enough static friction on the surface of each cell so that the cell cannot move under the vibration level that the pack is designed for. The cells are mechanically characterized and this compression force is elastic in nature and does not deform the cells permanently so the pack can be tensioned and released multiple times if required. There are spacers between each cell which go across the majority or preferably the full length of the cell, so that under compression there exists a channel for the air to flow through. The result is that the battery cells do not need to be fastened or bound to the structure or each other since the compression prevents movement. This allows for a simple structure with few fasteners and low manufacturing cost, and allows for any cell to be serviced by releasing the mechanism, replacing the cell, and tensioning the mechanism. Preferably, for extra safety, removable retaining brackets run across the rows of cells to make certain no cells fall out in any case.

According to yet another aspect of the invention, the tensioning mechanism comprises a plurality of tubes, bars, or rods (tensioning bars) running the full length of the rows of cells, located in pairs above and below each row of cells, each with a mechanism on the front end to pull on the tension bar while the far end is fixed to the far end of the rows of cells. The location of the tension bars is supported by a plurality of vertical sheets (columns) that are spaced out along the length of the rows of cells and have holes for each tension bar to sit in and holds them in place. The mechanism may be a bolt that is tightened up to a certain fixed point where it torques to lock in place. The total displacement is calculated such that for any batch of cells manufactured within a given tolerance A) is taking into account the tolerance stack up of the battery cells and spacers, B) creates sufficient compression to ensure cells cannot slide against spacers due to vibration while in operation, and C) the compression remains elastic meaning no permanent deformation will happen to the cells due to this compressive displacement. Springs may be introduced to the tensioning mechanism if this cannot be achieved by the elasticity of the cells themselves, however this has not been necessary in the present embodiment of the invention. The current invention proposes a design architecture and tensioning technology that allows a technician to release the tension from the pack, service a faulty cell or module, and re-tension the pack in a short period of time without interfering with other systems on the vehicle. The tensioning bars also provide a structure for routing electrical wires and cables inside the battery pack.

According to yet another aspect of the invention, the enclosure is insulated so that it can operate at high efficiency in all climates including extreme cold or hot with minimal passive or uncontrolled cooling or heating. To further prevent thermal bridging, the weight of the battery pack is supported by a plurality of blocks made of a material with low thermal conductivity and high compressive strength and the spaces between blocks are insulated. The battery pack structure is fastened to the mounting brackets by using shoulder bolts or bolts with sleeves made of a low conductivity, high strength material such as stainless steel. At least one bolt may go all the way through each block to fasten the battery pack directly to the vehicle, or bolts may be layered, such that no individual bolt fully penetrates the blocks to further reduce thermal bridging.

According to yet another aspect of the invention, there is provided a battery pack for providing a prescribed voltage comprising:
a plurality of battery cells respectively configured to provide cell voltages and electrically interconnected to form the prescribed voltage of the battery pack;
a housing comprising a container defining an interior configured to receive the battery cells, wherein the container comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction, wherein the housing is configured to permit passage of the battery cells through the container for transferring the battery cells between an exterior of the housing and the interior;
an array of rails in the container, wherein the rails respectively extend longitudinally of the container between opposite ends of the rails, wherein the rails are arranged in spaced parallel relation to each other, wherein the array comprises plural pairs of the rails in which respective ones of the pairs of the rails are spaced apart in the second transverse direction by a distance substantially equal to a dimension of a respective one of the battery cells in the second transverse direction, so as to form longitudinally-extending slots for receiving the battery cells in plural longitudinally-extending rows, wherein the array of the rails is supported in fixed relation to the container;
a plurality of upstanding planar panels respectively oriented substantially normal to the longitudinal axis and arranged at longitudinally spaced positions in the container, wherein the panels are configured to support the array of the rails passing therethrough, wherein a first endmost one of the panels is at or adjacent first ones of the opposite ends of the rails and a second endmost one of the panels is at or adjacent second ones of the opposite ends of the rails and wherein the endmost panels delimit therebetween, in the longitudinal direction, a battery-receiving volume in the interior within which the battery cells are received in the rows;
a plurality of spacers supported between each adjacent pair of the battery cells in a common one of the rows to maintain adjacent ones of the battery cells in the common row in longitudinally spaced relation to each other;
wherein the panels and the spacers are slidably supported on the rails so as to be freely movable relative thereto along the longitudinal axis; and
pairs of stoppers respectively supported on the rails outwardly of the endmost panels relative to the battery-receiving volume and configured for butting engagement with the endmost panels for applying compressive force on the rows of the battery cells to maintain the battery cells in fixed location within the container.

In effect, the first transverse direction is analogous to a depth of the container, and the second transverse direction is analogous to a height of the container.

In the illustrated arrangements, when the array includes a plurality of the slots in the second transverse direction of the container, the spacers including an intervening set of the spacers disposed between adjacent ones of the rails of each adjacent pair of the slots relative to the second transverse direction so as to bridge between the adjacent slots relative to the second transverse direction.

In the illustrated arrangements, first ones of the pairs of stoppers are affixed to respective ones of the rails and second ones of the pairs of stoppers are longitudinally movable relative to the respective rails.

In the illustrated arrangements, sets of the second ones of the pairs of stoppers, which are adjacent in a crosswise direction to the longitudinal axis, are interconnected to uniformly apply force in said crosswise direction across the second endmost panel.

In the illustrated arrangements, the battery pack further includes longitudinally-extending retaining brackets supported outwardly of the rows of the battery cells and intermediate respective ones of each pair of the rails forming the slots relative to the second transverse direction, wherein the retaining brackets are configured for butting engagement with peripheries of the battery cells in the rows to resist movement in the first transverse direction.

In the illustrated arrangements, when the array of the rails includes a plurality of the slots in the first transverse direction and in the second transverse direction of the container, adjacent ones of the rows of the battery cells relative to the first transverse direction are uniformly spaced apart by a first distance greater than a second distance between adjacent ones of the rows relative to the second transverse direction.

In the illustrated arrangements, when the array of the rails includes a plurality of the slots in the first transverse direction and in the second transverse direction of the container and when the housing is breathably fluidically sealed and contains a gaseous heat transfer medium, the battery pack further includes a thermal fluid conditioning unit configured to (i) circulate the heat transfer medium in the housing and adapted to convey heat and (ii) regulate a temperature of the battery cells, wherein the thermal fluid conditioning unit comprises:
a fan in the container and located outwardly of the battery-receiving volume at or adjacent the second ends of the rails, wherein the fan comprises a plurality of blades rotatable around a rotational axis oriented parallel to the longitudinal axis of the housing and centered relative to the array of rails, wherein the fan is configured to generate a flow of the heat transfer medium within the container in which the heat transfer medium moves from a second one of the ends of the container, proximal to the second ends of the rails, and along a periphery of the container towards a first one of the ends of the container proximal to the first ends of the rails, inwardly towards a central longitudinally-extending portion of the battery-receiving volume and subsequently towards the second end of the container, and
a heat exchanger in the container and arranged in series with the fan, wherein the heat exchanger is configured to add or extract heat from the gaseous heat transfer medium.

In the illustrated arrangements, the heat exchanger is disposed downstream from the fan relative to the flow of the heat transfer medium in the housing.

In the illustrated arrangements, the thermal fluid conditioning unit is supported in fixed relation to the array of the rails by the second ones of the pairs of stoppers.

In the illustrated arrangements, when the spacers have thicknesses measured in the longitudinal direction for providing the spaced relation of the adjacent battery cells, the thicknesses of the spacers are in a range from 1 mm to 5 mm.

In the illustrated arrangements, the battery-receiving volume is thermally insulated from the housing by an encapsulating layer of thermal insulation having a R-value of at least one.

In the illustrated arrangements, when there is provided a mounting bracket external to the housing, outermost ones of the rails in the array, which are closest to walls of the container, are fastened to the external mounting bracket through the container to support the array of the rails in fixed relation to the container.

In the illustrated arrangements, the outermost rails of the array are supported in spaced relation to the container by thermally insulating bodies configured to receive substantially thermally nonconductive fasteners interconnecting the outermost rails and the external mounting bracket.

In one of the illustrated arrangements, distinct substantially thermally nonconductive fasteners are carried in the thermally insulating bodies and in longitudinally spaced relation to each other for interconnecting the outermost rails and the external mounting bracket including a first set of the fasteners configured to interconnect the external mounting bracket and the thermally insulating bodies and a second set of the fasteners configured to interconnect the thermally insulating bodies and the outermost rails.

In the illustrated arrangements, when the battery cells are prismatic in shape and have outer surfaces each having an opposite pair of large faces spaced apart in a first dimension of the battery cell and substantially normally oriented to the longitudinal direction, an opposite pair of first narrow faces spaced apart in a second dimension crosswise to the first dimension and substantially normally oriented to the first transverse direction and an opposite pair of second narrow faces spaced apart in a third dimension crosswise to both the first and second dimensions of the battery cell and substantially normally oriented to the second transverse direction, wherein the first dimension is smaller than the second and third dimensions; and when end portions of the large faces of the battery cells defining portions of peripheral edges thereof are resiliently compressible in a direction along the first dimension, the spacers are arranged for butting engagement with the end portions of the large faces of the battery cells such that the battery cells are resiliently compressed upon application of the compressive force by the stoppers.

According to yet another aspect of the invention, there is provided a battery pack for providing a prescribed voltage comprising:
a plurality of battery cells respectively configured to provide cell voltages and electrically interconnected to form the prescribed voltage of the battery pack;
a housing defining an interior configured to receive the battery cells, wherein the housing comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction;
wherein the battery cells are arranged in an array of plural longitudinally-extending rows arranged side-by-side in both the first and second transverse directions;
wherein the battery cells of each row are in spaced relation to each other;
wherein the rows of the battery cells are in spaced relation to each other and to the housing so as to form a peripheral gap;
wherein the housing is breathably fluidically sealed and contains a gaseous heat transfer medium; and
a thermal fluid conditioning unit configured to (i) circulate the heat transfer medium in the housing and adapted to convey heat and (ii) regulate a temperature of the battery cells, wherein the thermal fluid conditioning unit comprises:
   a fan located in the peripheral gap of the housing and generally at a first one of the ends of the housing, wherein the fan comprises a plurality of blades rotatable around a rotational axis oriented parallel to the longitudinal axis of the housing and centered relative to the array of the battery cells, wherein the fan is configured to generate a flow of the heat transfer medium within the container in which the heat transfer medium moves from the first end of the housing and along a periphery of the container towards a second one of the ends of the housing distal to the fan, inwardly towards a central longitudinally-extending portion of the array of the battery cells and subsequently towards the first end of the housing; and
   a heat exchanger in the container and arranged in series with the fan, wherein the heat exchanger is configured to add or extract heat from the gaseous heat transfer medium.

In the illustrated arrangements, the heat exchanger is disposed downstream from the fan relative to the flow of the heat transfer medium in the housing.

In the illustrated arrangements, spacing between adjacent ones of the battery cells of a common one of the rows ranges from 1 mm to 5 mm.

According to yet another aspect of the invention, there is provided a battery pack for providing a prescribed voltage, in combination with an external mounting bracket, comprising:
a plurality of battery cells respectively configured to provide cell voltages and electrically interconnected to form the prescribed voltage of the battery pack;
a housing defining an interior configured to receive the battery cells, wherein the container comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction;
an array of rails in the container, wherein the rails respectively extend longitudinally of the container between opposite ends of the rails, wherein the rails are arranged in spaced parallel relation to each other, wherein the array comprises plural pairs of the rails in which respective ones of the pairs of the rails are spaced apart in the second transverse direction by a distance substantially equal to a dimension of a respective one of the battery cells in the second transverse direction, so as to form longitudinally-extending slots for receiving the battery cells in plural longitudinally-extending rows, wherein the array of the rails is supported in fixed relation to the container;
a plurality of upstanding planar panels respectively oriented substantially normal to the longitudinal axis and arranged at longitudinally spaced positions in the container, wherein the panels are configured to support the array of the rails passing therethrough, wherein a first endmost one of the panels is at or adjacent first ones of the opposite ends of the rails and a second endmost one of the panels is at or adjacent second ones of the opposite ends of the rails and wherein the endmost panels delimit therebetween, in the longitudinal direction, a battery-receiving volume in the interior within which the battery cells are received in the rows;
wherein the panels are supported on the rails so as to be detached from the housing;
wherein the endmost panels are arranged to be urged towards each other to apply compressive force on the rows of the battery cells to maintain the battery cells in fixed location within the container; and
wherein outermost ones of the rails in the array, which are closest to walls of the container, are fastened to the external mounting bracket through the container to support the array of the rails in fixed relation to the container.

In the illustrated arrangements, the outermost rails of the array are supported in spaced relation to the container by thermally insulating bodies configured to receive substantially thermally nonconductive fasteners interconnecting the outermost rails and the external mounting bracket.

In one of the illustrated arrangements, distinct substantially thermally nonconductive fasteners are carried in the thermally insulating bodies and in longitudinally spaced relation to each other for interconnecting the outermost rails and the external mounting bracket including a first set of the fasteners configured to interconnect the external mounting bracket and the thermally insulating bodies and a second set of the fasteners configured to interconnect the thermally insulating bodies and the outermost rails.

In the illustrated arrangements, the battery-receiving volume is thermally insulated from the container by an encapsulating layer of thermal insulation having a R-value of at least one.

According to yet another aspect of the invention, there is provided a fully serviceable battery pack comprising:
a battery pack enclosure mounted on a vehicle containing a plurality of battery cells, wherein individual said battery cells can be serviced and replaced by a technician without removing said battery pack from said vehicle, wherein said enclosure protects said battery cells and provides an air flow boundary;
a plurality of tension bars integrated into the structure of said enclosure, wherein said tension bars are part of a mechanism to apply slight compression to said battery cells, wherein the length of said tension bars considers the elastic modulus and tolerance stacking of said battery cells, wherein said mechanism can be released and reapplied by a technician with basic tools to allow said battery cells to be removed and replaced; and
a closed air flow loop powered by a fan or blower, wherein said air exchanges heat with an external source of heating or cooling and passes between said battery cells through channels of 1 to 5 millimeters wide to exchange heat with said battery cells, wherein said channels are enforced by spacers going the majority or full length of said battery cells.

In the illustrated arrangement, the external source of heating or cooling is provided by a thermal management system, wherein said thermal management system monitors the temperature of said battery cells or said air inside said battery pack and delivers heating and cooling as needed, wherein said heating and cooling may be sourced from different components onboard the vehicle or from the ambient environment and may involve the use of a refrigerant and/or coolant.

In the illustrated arrangements, the air inside said battery pack is thermally insulated from the outside environment with an R value of at least 1, wherein structural blocks of a low thermal conductivity material are integrated into said insolation, wherein fasteners such as bolts of high strength and low thermal conductivity material such as stainless steel are passed through said blocks to hold said battery pack in place and increase structural rigidity.

In one arrangement, the bolts do not penetrate all the way through said blocks and insulating layer, but instead are layered such that some fasten said block to the exterior structure, and some fasten said block to the interior structure in order to further prevent thermal bridging.

### BRIEF DESCRIPTION OF THE DRAWINGS

FIG. 1 is a perspective view of an arrangement of battery pack according to the present invention mounted on a vehicle at a suitable location for full serviceability of the battery pack;

FIG. 2 is a side view of the arrangement of battery pack of FIG. 1 in which a lid thereof is removed to show an interior of the battery pack;

FIG. 3 is a cross-sectional view along line S1 in FIG. 2 but showing the lid in a closed position as in FIG. 1;

FIG. 4 is a cross-sectional view along line S1 in FIG. 2 showing the lid in an open position in which the lid is detachably removed;

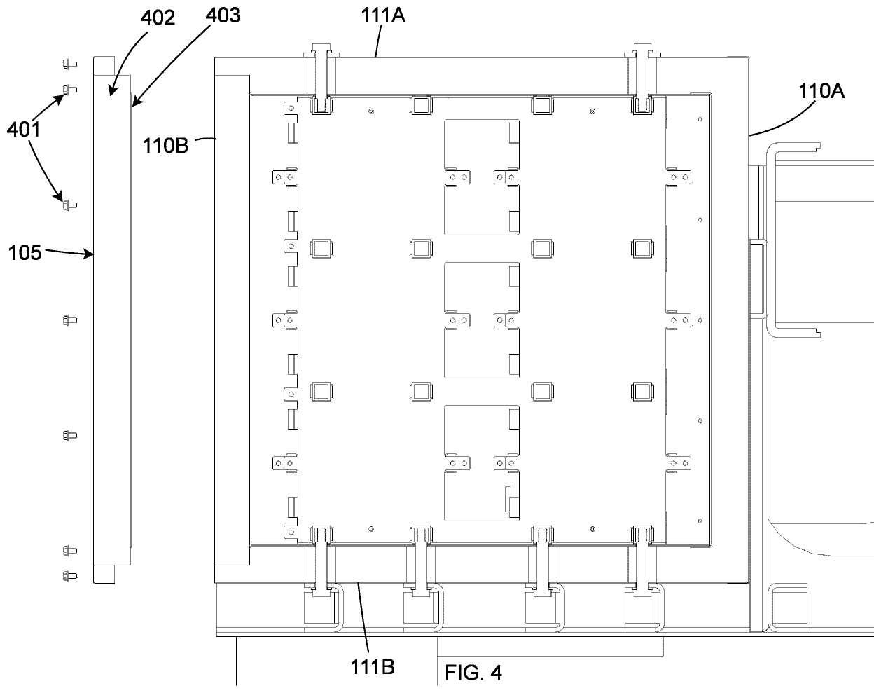

FIG. 5 is a cross-sectional view along line S2 in FIG. 3;

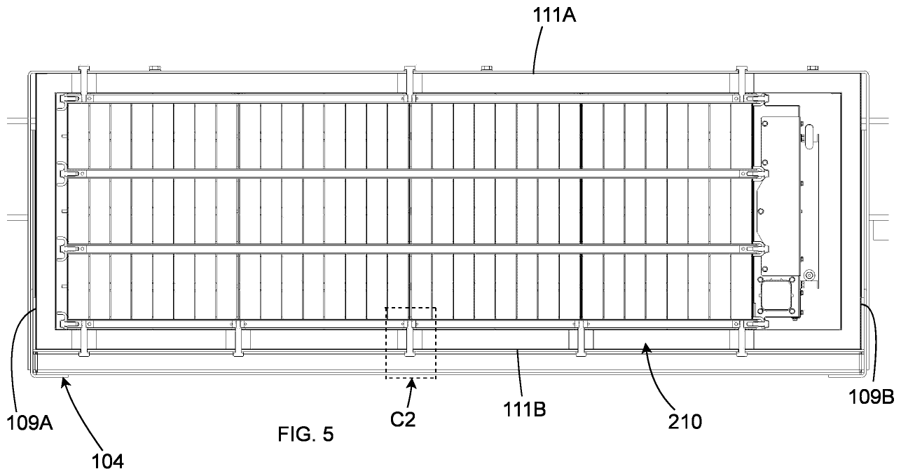

FIG. 6 is a close up or enlarged partial view of an area indicated at C1 in FIG. 2 showing a section of a row of battery cells, oriented normal to the surface of the battery cells that faces outwards, and a spacing between battery cells;

FIG. 7 shows, in perspective view, a cross-section of the arrangement of battery pack taken along either one of lines S3A or S3B in FIG. 2 and showing the geometry and arrangement of the spacers;

FIG. 8 is a cross-sectional view along line S4 in FIG. 2 to show a top or plan view of the air flow path;

FIG. 9 is an enlarged partial view of area C3 in FIG. 2 showing a tensioning mechanism;

FIG. 10 is an enlarged partial view of area C4 in FIG. 2 showing an alternate tensioning mechanism for top and bottom rows of battery cells;

FIG. 11 is an end view of the arrangement of battery pack with a housing removed and showing a tension bar pattern;

FIG. 12 is a bottom perspective view from an opposite end of the arrangement of battery pack with a housing removed and showing fastening locations on a bottom of the battery pack;

FIG. 13 is an enlarged partial view of area C2 in FIG. 2 showing an arrangement for attaching the battery pack to a bracket structure;

FIG. 14 is a similar view to FIG. 13 showing an alternate mounting arrangement for attaching to the bracket structure; and

FIG. 15 is an exploded view of one of the ends of the arrangement of battery pack showing mounting of a thermal fluid conditioning unit.

### DETAILED DESCRIPTION

In the following text, the terms “battery cell” and “cell” may be used interchangeably and may refer to either an individual cell or a module of cells, which may be of any chemistry or configuration.

With reference to the accompanying drawings, there is shown a battery pack 101 allowing serviceability down to the cell level by a technician. Such architecture allows that the battery pack remain in place on a supporting structure, for example a vehicle 102, and any faulty cell or plurality of faulty battery cells 201 can be replaced in a convenient and timely manner.

Generally speaking, the vehicle 102 comprises a frame or chassis 103 which is rollably supported for movement across a road surface, for example by carrying a plurality of rotatable traction elements such as wheels. The vehicle 102 further includes a mounting bracket 104 on each side of the chassis 103 and configured to support one of the battery packs. As such, the vehicle 102 is configured to carry a pair of the battery packs, one on each side thereof to be accessible for servicing.

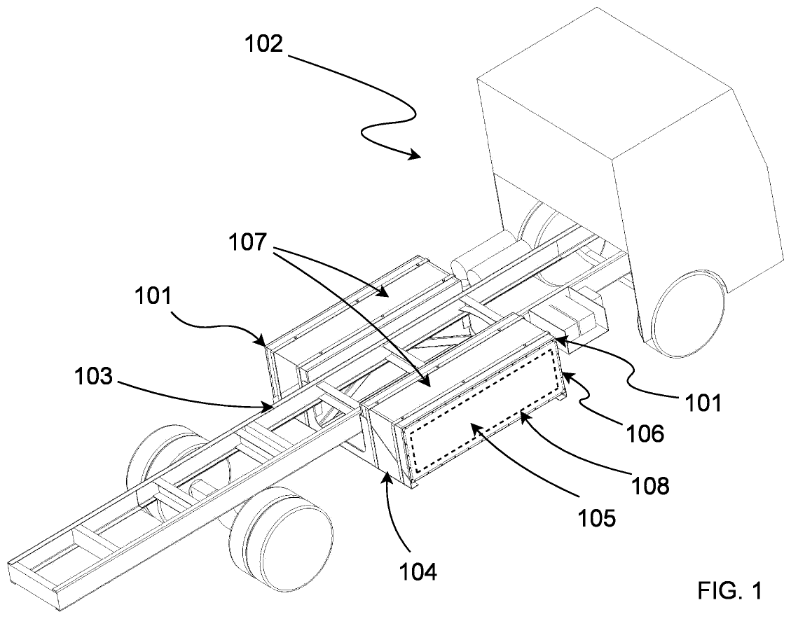

The battery pack is positioned on the vehicle where there is no interference with anything while removing the battery cells or other components inside the battery pack. A suitable location is illustrated in FIG. 1 on a generic truck chassis. In the illustrated arrangement, a battery pack 101 is located on either side of a vehicle 102 along chassis rails 103 of the vehicle and on a mounting bracket 104 supported on a respective one of the chassis rails and designed for this purpose with a lid 105 of a housing 106 of the battery pack accessible from one side of the housing. The lid 105 preferably provides an airtight seal with a containment portion 107 of the housing 106 of the battery pack configured to receive the cells. The lid or access door 105 is supported on the containment portion, or container, 107 for movement relative to an access opening 108 in one of the sides of the container (shown in stippled line behind the lid 105 in FIG. 1). The access opening 108 is configured to permit passage of the battery cells therethrough for transferring the battery cells between an exterior of the housing and an interior of the containment portion. The access door 105 is movable relative to the access opening between a closed position in which the access opening 108 is substantially covered by the access door 105 to retain the battery cells in the container and an open position in which the access opening is substantially unobstructed by the access door to permit transfer of the battery cells between the exterior and the interior. Thus, the housing is enclosed when the access door is in the closed position. More specifically, it will be appreciated that in the illustrated arrangement, the access door 105, in the closed position, forms a fluidic seal with the container 107 to fluidically close and seal the access opening 108. Furthermore, in the illustrated arrangement, the access door or lid is detachably mounted to the container 107 to be movable between the closed and open positions.

In the illustrated arrangement of vehicle 102, the mounting bracket 104, which is external to the battery pack 101, includes a base or floor portion and opposite end walls, which are triangular in shape. Thus, the access door 105 remains unobstructed by the mounting bracket 104 to be movable between the open and closed positions.

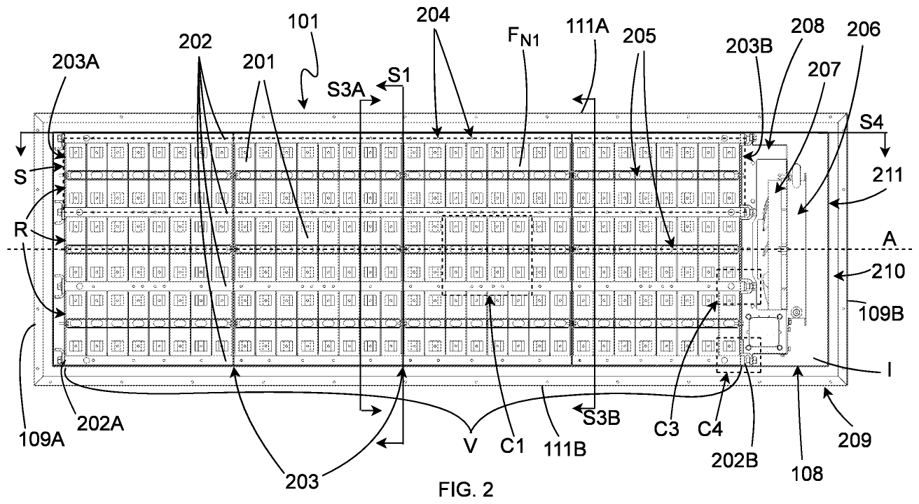

FIG. 2 provides a side view of the battery pack 101 with the lid 105 removed. This illustrates what a technician will see while performing service. The electrical layout including bus bars, circuit boards, etc. is not shown for clarity and convenience of illustration. The electrical layout is designed such that it does not interfere heavily with servicing. In the illustrated embodiment, the battery cells 201 are arranged in 6 rows R: 3 high by 2 deep, and 32 long for a total of 192 battery cells 201. The rows R of cells are placed between rows of tubes, pipes, or bars 202, herein referred to as “tension bars” or rails, which are passed through a series of bent sheet metal columns 203 to make up the structure inside the battery pack 101. Preferably, the tension bars 202 have holes 204 for cable harness mounting. This way the cable harness does not interfere with serviceability. In the illustrated arrangement, long removable retaining brackets 205 are used for extra safety and ease of assembly in front and behind each row of cells 201. There is a heat exchanger 206 in-line with a fan or blower 207, which is inside a shroud 208. The shroud 208 has an access panel for the fan 207 which has been removed in FIG. 2 to show the fan 207. It will be appreciated that the illustrated embodiment represents only one of many possible configurations. The number, arrangement, geometry, etc. of battery cells 201, and the configuration of the heat exchanger 206 with the shroud 208 and fan or blower 207, and the use of access panels may be modified to suit application requirements. Every serviceable component can be accessed from this side. The battery cells 201 in the back row can be accessed by first removing those directly in front of them.

In other words, the battery pack 101, which acts to provide or output a prescribed voltage, generally comprises a plurality of battery cells 201 respectively configured to provide cell voltages, for example electrochemically; and electrically interconnected to form the prescribed voltage of the battery pack, for example by electrical interconnection of the rows R in parallel, where each row has a subset of the cells electrically interconnected in series; and a housing 106 comprising a container 107 defining an interior “I” configured to receive the battery cells 201. The container 107 comprises opposite ends 109A and 109B spaced apart along a longitudinal axis A of the housing; a first pair of opposite sides 110A and 110B spaced apart in a first transverse direction crosswise to the longitudinal axis; and a second pair of opposite sides 111A and 111B spaced apart in a second transverse direction crosswise to both the longitudinal axis and the first transverse direction. In effect, the first transverse direction is analogous to a depth of the container, and the second transverse direction is analogous to a height of the container. As such, the second pair of opposite sides may be referred to as top and bottom of the container, where the top is in this case indicated at 111A and the bottom is indicated at 111B. The housing 106 is configured to permit passage of the battery cells through the container for transferring the battery cells between an exterior of the housing and the interior I. More specifically, this is afforded by the access opening 108.

In the illustrated arrangement, the container 107 comprises a pair of end walls defining the opposite ends 109A, 109B; a pair of first side walls defining the first pair of opposite sides 110A, 110B; and a pair of second side walls defining the second pair of opposite sides 111A, 111B. Since the second transverse direction is effectively the height direction of the container, the second side walls may be referred to as upper and lower walls of the container. In the illustrated arrangement, the container 107 is rectangular prismatic in shape. The walls of the container 107 are made of metallic material for durability.

Further to the housing 106, the battery pack additionally comprises an array of rails 202 in the container, where each rail extends longitudinally between opposite ends 202A, 202B thereof. Basically, the rails are longitudinally elongated frame members. In the array, the rails 202 are arranged in spaced parallel relation to each other. Furthermore, respectively spaced parallel relation inside the container. The array comprises plural pairs of the rails in which constituent pairs of each pair are spaced apart in the depth direction by a distance substantially equal to a dimension of a respective battery cell in the depth direction, so as to form longitudinally-extending slots S for receiving the battery cells 202 in plural longitudinally-extending rows R. The array of the rails is supported in fixed relation to the container 107.

Thus, the battery cells 201 are arranged in an array of plural longitudinally-extending rows R arranged side-by-side in both the depth and height directions.

In the illustrated arrangement, intermediary ones of the rails relative to the height direction act to form the battery-receiving slots both above and below the same. This may act to reduce a number of rails and to reduce a volume of the array of battery cells.

It will be appreciated that a longitudinal direction of the housing may be considered the same as an axial direction of the housing to which the rails are respectively parallel in orientation. That is, the axial and longitudinal directions are directed along the longitudinal axis A.

Furthermore, the battery pack 101 includes a plurality of upstanding planar panels 203 respectively oriented substantially normal to the longitudinal axis A and arranged at longitudinally spaced positions in the container. The panels 203 are configured to support the array of the rails passing therethrough. Thus, the panels 203 and the rails 202 collectively form a frame for supporting the battery cells in the array of rows in the container. A first endmost one of the panels 203A is at or adjacent first ends 202A of the rails and a second endmost panel 203B is at or adjacent second ends 202B of the rails and the endmost panels 203A, 203B delimit therebetween, in the longitudinal or axial direction of the housing, a battery-receiving volume V in the interior I of the container within which the battery cells are received in the rows R. Thus, the battery-receiving volume V is a portion or subset of the interior I As such, the panels 203 act as partition walls located at spaced positions between select pairs of adjacent battery cells in a common row. In the illustrated arrangement, the panels include feet 203C at upper and lower ends thereof relative to the height direction to assist in supporting the panels in upstanding orientation. The feet are in the form of flanges connected to main bodies 203D of the panels lying in axial planes of the housing 106. The flanges are planar and lie in generally horizontal planes. Intermediary ones of the panels disposed at intermediary locations in the battery-receiving volume V have upper and lower extending axially outwardly in opposite directions from the main bodies, so as to be I-shaped in side view, and endmost panels delimiting axially opposite ends of the battery-receiving volume have upper and lower flanges extending in one axial direction into the battery-receiving volume V, so as to be C-shaped in side view. In the illustrated arrangement, the endmost panels are integrally formed from sheets of metallic material, and each of the intermediary panels is formed from a pair of C-shaped metallic sheets arranged back-to-back with the main bodies oriented to face one another.

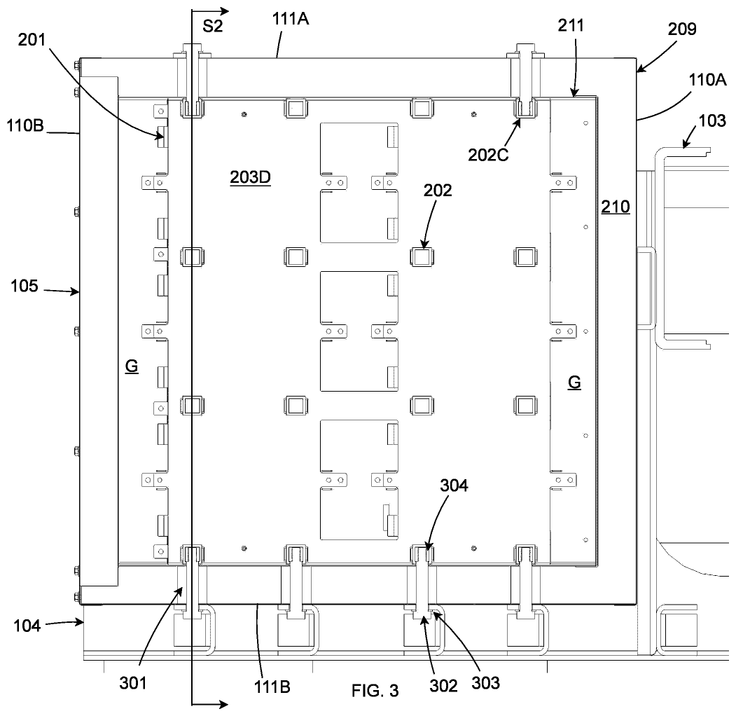

As shown in FIGS. 2 and 3, the rail array includes a plurality of the slots S in the depth direction and in the height direction. In the illustrated arrangement, the rail array has two slots in the depth direction and three slots in the height direction. Furthermore, in the illustrated arrangement, adjacent rows of the battery cells relative to the depth direction are uniformly spaced apart by a first distance D1 greater than a second distance D2 between adjacent rows relative to the height direction. More specifically, adjacent rows in the depth direction are uniformly spaced apart by a larger distance different than a spacing or distance between adjacent rows in the height direction.

The illustrated arrangement of battery pack further includes retaining brackets 205 supported outwardly of the rows R of the battery cells 201 and intermediate respective ones of each pair of the rails 202 forming the slots S relative to the height direction. The retaining brackets 205 are configured for butting engagement with peripheries of the battery cells 201 in the rows to resist movement in the depth direction. In the illustrated arrangement, the retaining brackets 205 are supported by fastening to the panels 203, which are enlarged in a radial direction to the axis A relative to the rows of the battery cells.

In the illustrated arrangement, the battery cells 201 are prismatic in shape and have outer surfaces each having an opposite pair of large faces F_{L} spaced apart in a first dimension of the battery cell and substantially normally oriented to the longitudinal direction, an opposite pair of first narrow faces F_{N1} spaced apart in a second dimension crosswise or transverse to the first dimension and substantially normally oriented to the depth direction and an opposite pair of second narrow faces F_{N2} spaced apart in a third dimension crosswise to both the first and second dimensions of the battery cell and substantially normally oriented to the height direction. The first dimension is smaller than the second and third dimensions. The battery cells of a common row are uniformly oriented relative to the rails 202 forming the slot that receives the row, and are disposed substantially parallel to each other with their large faces F_{L} oriented as if to face adjacent cells in the same row. It will also be appreciated that end portions of the large faces F_{L} of the battery cells defining portions of peripheral edges thereof are resiliently or elastically compressible in a direction along the first dimension, which will be better appreciated shortly. The peripheral edges and the outer surfaces collectively define the periphery of each battery cell.

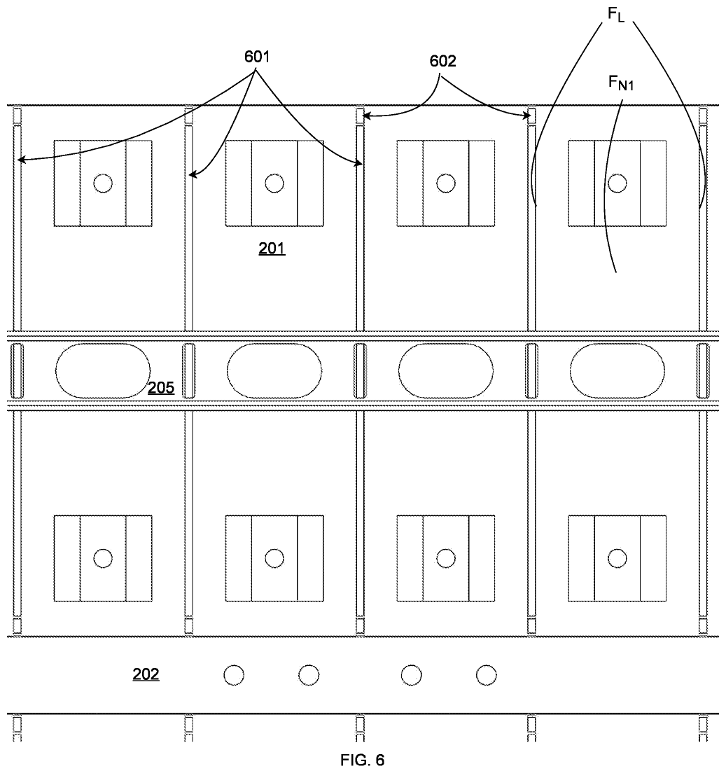

FIG. 6 provides a close-up view of the rows of cells 201 to illustrate the air channels 601 that allow air to flow through the rows of cells 201. The air channel 601 spacing (channel width) may be variable and is preferably optimized to provide an even temperature distribution between battery cells 201 in different positions within the battery pack 101. Spacings from 1 to 5 millimeters are suitable to achieve high enough flow rates with low enough pressure drop across the rows of cells 201, while still providing an adequate heat transfer coefficient between the air and the surface of the cells. In the illustrated embodiment, the spacing is enforced by sheet metal spacers 602 placed between battery cells 201. The sheet metal thickness determines the air channel 601 spacing.

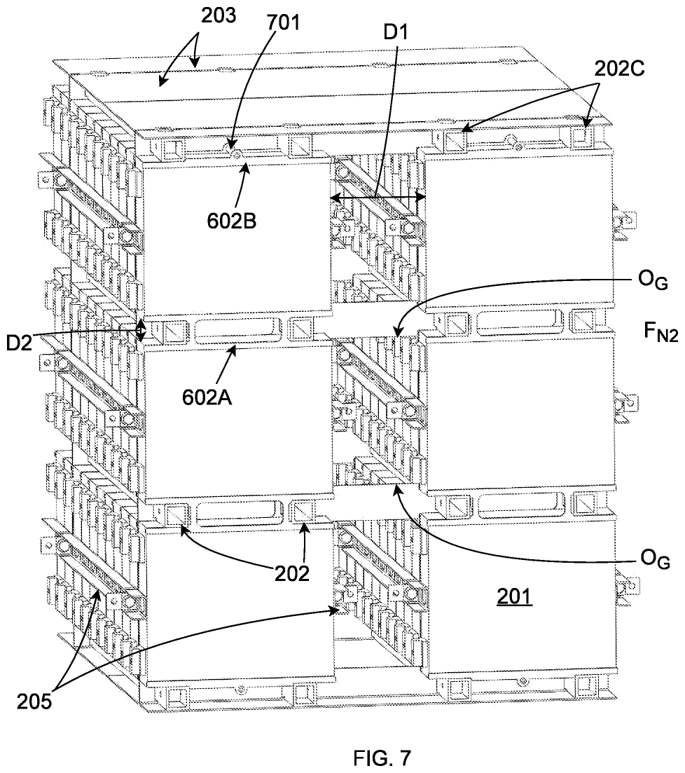

The sectioned view illustrated in FIG. 7 shows how the tension bars 202 and spacers 602 are integrated into the structure. Preferably, there are 2 tension bars 202 above and below each row of cells, providing a space for wiring harness along each row. The illustrated embodiment requires 16 tension bars 202 for 6 rows of battery cells 201. It can be observed in FIG. 7 that there are two styles of spacers 602. Those in the middle 602A with battery cells 201 above and below can be supported by the tension bars 202 themselves as shown. Those at the top or bottom 602B can be supported by thin tubes or rods 701 that run the length of the structure. In both cases, the spacers are integrated with the structure and are not meant to be removable for servicing cells, but are free to slide along the length of the pack.

In other words, the battery pack 101 further includes a plurality of spacers 602 supported between each adjacent pair of the battery cells in a common one of the rows to maintain adjacent ones of the battery cells in the common row in longitudinally spaced relation to each other.

As shown in FIG. 7, there is provided a set of spacers 602 disposed between adjacent rails of each adjacent pair of the slots relative to the height direction so as to bridge between the adjacent slots relative to the height direction. In the illustrated arrangement, the foregoing is not applicable to adjacent slots relative to the depth direction.

The spacers 602, which have thicknesses measured in the longitudinal direction for providing the spaced relation of the adjacent battery cells, are sized in thickness in a range from 1 mm to 5 mm. In the illustrated arrangement, the spacers are uniform in thickness in the longitudinal direction and are in the form of planar bodies.

In another arrangement, the spacers may increase in thickness in the axial direction along the longitudinal axis directed away from an air flow source. In such an arrangement, the thickness of the spacers closest to the air flow source is no smaller than about 1 mm, that is the spacers located in a common axial plane closest to the air flow source, and the thickness of the spacers farther and particularly farthest from the air flow source is no larger than about 5 mm.

Consequently, the battery cells 201 of each row R are in spaced relation to each other, and furthermore, the rows R of the battery cells are in spaced relation to each other and to the housing 106, so as to form a peripheral gap G. In the illustrated arrangement, the peripheral gap is provided only along the opposite sides 110A and 110B of the container 107.

The spacers 602, and in the illustrated arrangement the panels 203, are slidably supported on the rails so as to be freely movable relative thereto along the longitudinal axis. Thus, the panels are supported on the rails so as to be detached from the housing.

In the illustrated arrangement, the spacers 602 are planer in shape and oriented to lie in axial planes of the container.

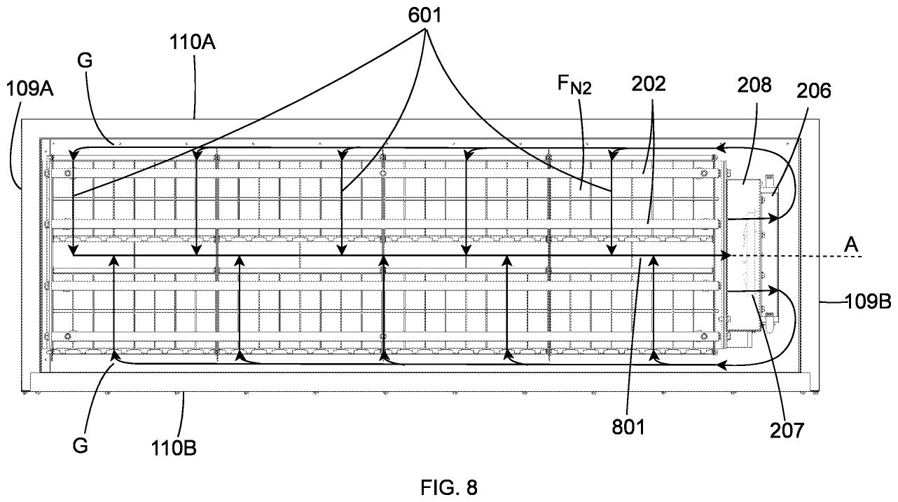

The air flow path is illustrated in FIG. 8, which provides a top view of the battery pack with the outer layer and columns 203 hidden. The air flows in a closed loop, bounded by the inner walls of the enclosure. In the illustrated embodiment, the fan 207 is shown beneath a shroud 208 and powers the air flow through the loop. The air is pushed through the heat exchanger 206. Heat exchange between an external source of heating or cooling and the air occurs here. The air then travels through outer air ducts in the peripheral gap G, then through the air channels 601 between the battery cells 201 in parallel. Heat transfer between the air and the battery cells takes place along the air channels 601. The air flows into duct 801 and back to the fan 207. This is how heat exchange between the battery cells 201 and an external source is mediated through dry air within the battery pack 101.

In other words, the housing is breathably fluidically sealed, particularly when the lid 105 is in the closed position, meaning the housing is substantially fluidically sealed from an external environment such that there is no transfer of fluid therebetween unless there is a pressure gradient or differential between the interior of the housing and the external environment (of the housing), and consequently an amount of the gaseous heat transfer medium is substantially constant. Thus is formed a closed loop conditioning system. In the event of transfer of fluid between the housing and the external environment, the housing is selectively permeable, by way of an encapsulating membrane, to permit transfer of fluid having a threshold moisture content. In the illustrated arrangement, the threshold moisture content is about zero. Furthermore, the housing contains a gaseous heat transfer medium, in this case air, which is the gas surrounding the battery pack housing in an ambient environment thereof.

The battery pack includes a thermal fluid conditioning unit configured to (i) circulate the heat transfer medium in the housing and adapted to convey heat and (ii) regulate a temperature of the battery cells. The thermal fluid conditioning unit comprises a fan 207 in the container 107 and located outwardly of the battery-receiving volume V at or adjacent the second ends 202B of the rails, or in other words the fan is located in the peripheral gap of the housing and generally at one of the ends of the housing; and a heat exchanger 206 in the container and arranged in series with the fan 207. The heat exchanger is configured to add or extract heat from the gaseous heat transfer medium.

The fan 207 comprises a plurality of blades 207A rotatable around a rotational axis 207B oriented parallel to the longitudinal axis A of the housing and centered relative to the array of rails 202. The fan 207 is configured, for example by shaping of its blades and a corresponding rotational direction, to generate a flow of the heat transfer medium within the container 107, within voids between the components received in the container, in which the heat transfer medium moves from one of the ends of the container, in this case 109B, proximal to the second ends 202B of the rails, and along a periphery of the container in the gap G towards the other end of the container, in this case 109A, proximal to the first ends 202A of the rails. Then, the heat transfer medium, by action of the fan 207, moves inwardly towards a central longitudinally-extending portion of the battery-receiving volume V and subsequently towards the end 109B of the container. In the illustrated arrangement, the central duct of the housing is formed between the two sets of stacked rows relative to the height direction. Furthermore, the panels 203 include openings O_{G} between adjacent rows of the cells to permit passage of the gaseous heat transfer medium along the central duct.

It will be appreciated that the heat exchanger 206 is disposed downstream from the fan 207 relative to the flow of the heat transfer medium in the housing.

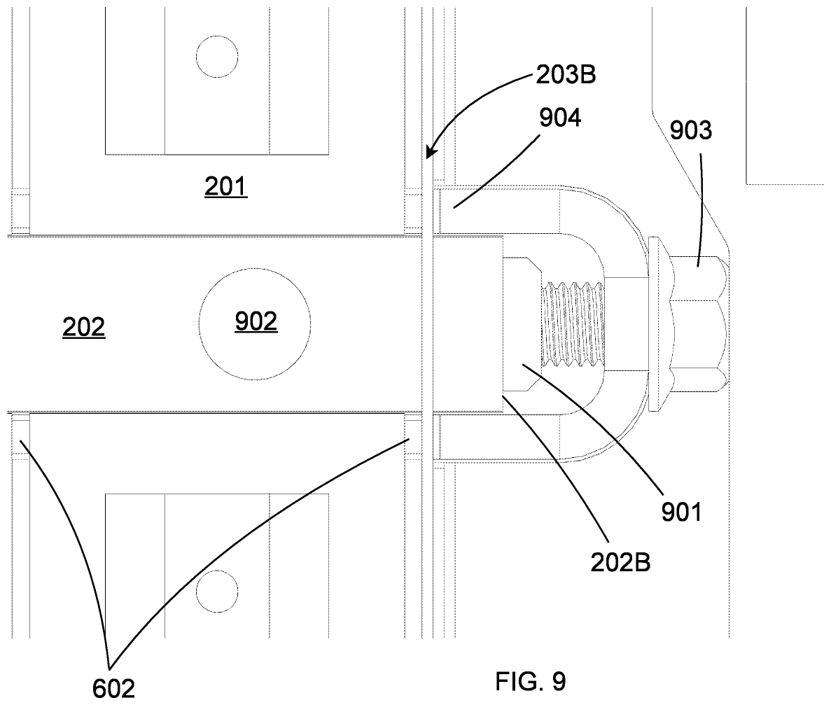

The tension bars 202 serve to apply a compressive axial force on the rows of cells as part of the tensioning mechanism. This is illustrated in FIG. 9, which shows the end of an individual tension bar 202 fastened to the end of the rows of battery cells 201. In the illustrated embodiment, there is a threaded steel insert 901 fitted inside the tension bar 202 and fastened with a solid rivet 902. A bolt, herein referred to as a “tension bolt” 903 is threaded into the insert 901, and in doing so exerts a force on the bracket 904, which in turn pushes on the spacer 602 through the column 203. The tensioning process is complete when the bracket 904 makes contact with the insert 901 and the tension bolt 903 is torqued to a certain specification. Since the tension bar 202 is fixed at the other end to the main column, the result is a predictable and controllable slight compression on the edges of the battery cells 201. This increases the rigidity and stability of the battery pack 101 internal structure and ensures that nothing moves. This way the materials do not slide against each other during vibrations, which could cause damage over time. The elastic properties of the battery cells 201 are characterized before the correct amount of compression can be determined, which becomes fixed by the geometry of the tensioning mechanism.

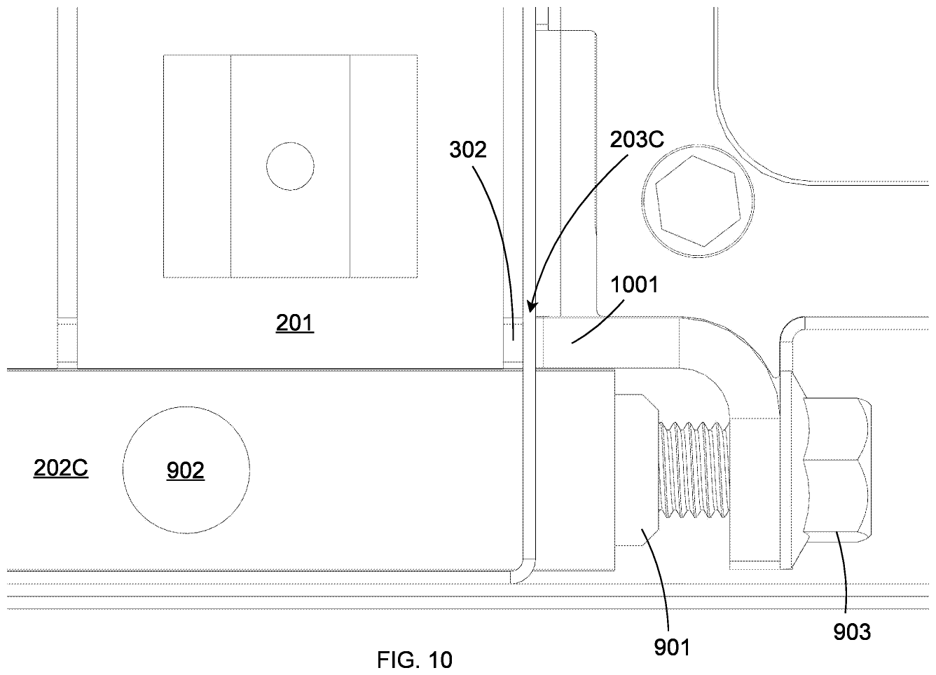

FIG. 10 illustrates the mechanism for the top and bottom tension bars 202. In this case, the bracket 1001 only pushes on one side, while the other side has nothing to push on. The bracket 1001 is configured therefor, for example by being appropriately sized and shaped for the aforementioned purpose. The brackets 904 and 1001 may take on any form and may or may not be made of bent sheet metal.

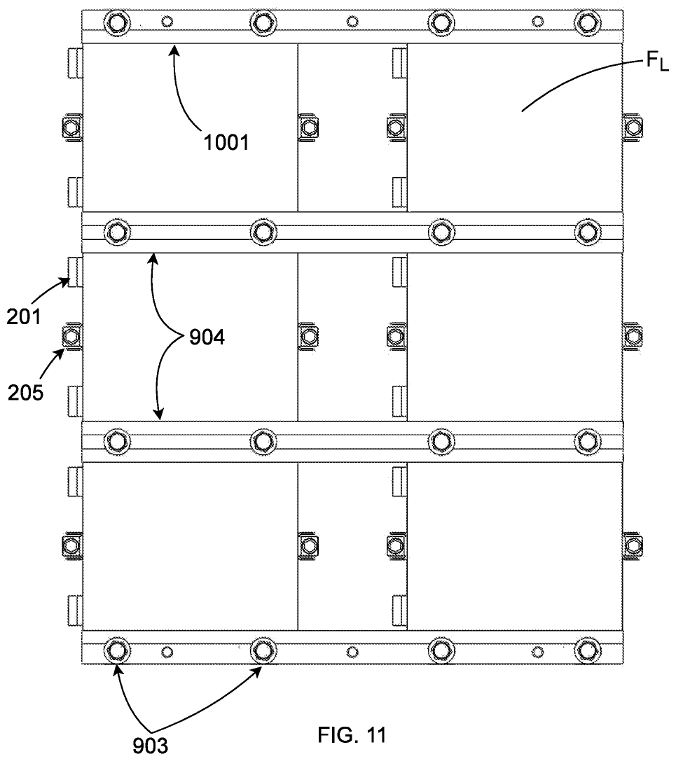

The tension bars 202 are used to provide a structure for the battery pack 101, as well as partition the battery cells 201 into a plurality of rows, providing a space for each row to slide in and out. FIG. 11 illustrates the tension bar 202 pattern from an end view. A technician loosens all of the tension bolts 903 (in this case, 16) to loosen the rows of cells allowing them to be replaced. After service, all tension bolts 903 are tightened again in a certain sequence and properly torqued. This process is highly repeatable and can be done by a briefly trained technician with basic tools.

In other words, the battery pack 101 includes pairs of stoppers 904 respectively supported on the rails 202 outwardly of the endmost panels 203A, 203B relative to the battery-receiving volume and configured for butting engagement with the endmost panels for applying compressive force on the rows R of the battery cells relative to the longitudinal or axial direction to maintain the battery cells 201 in fixed location within the container. That is, each rail receives a pair of the stoppers. A first one of each stopper pair is affixed to the rail carrying the stopper pair and a second one of the stopper pair is longitudinally movable relative to the supporting rail. Accordingly, the endmost panels are arranged to be urged towards each other to apply compressive force on the rows of the battery cells to maintain the battery cells in fixed location within the container.

To ensure uniform application of force, plural sets of the second stoppers of the stopper pairs, which are adjacent in a crosswise direction to the longitudinal axis, are interconnected to uniformly apply force in the crosswise direction across the spacers through the second endmost panel. In the illustrated arrangement, the stoppers which are located in-line relative to the depth direction are interconnected. In the illustrated arrangement, interconnection may be achieved by providing a common stopper supported at the second ends 202B of the rails that are located in-line relative to the depth direction.

To provide a resilient type of compression within the array of the battery cells, so that the cells can be predictably or controllably compressed after each servicing in which the overall array is loosened to facilitate removal of one or more cells independently of other cells, the spacers 602 are arranged for butting engagement with the end portions of the large faces F_{L} of the battery cells such that the battery cells are resiliently compressed upon application of the compressive force by the stoppers. Since the spacers of the illustrated arrangement engage the end portions of the battery cells, there is provided an intervening set of the spacers arranged to bridge between slots that are adjacent in the height direction and an endmost set of the spacers supported on the outermost rails relative to the height direction which engage the battery cells carried in one slot only.

To enhance servicing of components of the battery pack internal to the housing 106, the thermal fluid conditioning unit, which in the illustrated arrangement is formed by the fan 207 and the heat exchanger 206, is supported in fixed relation to the array of the rails 202 by the second ones of the pairs of stoppers, that is the movable stoppers supported generally at the second ends 202B of the rails. Furthermore, the thermal fluid conditioning unit is detachable from the housing and serviceable.

To help isolate the heat transfer or exchange between the gaseous heat transfer medium and the battery cells, the battery-receiving volume V is thermally insulated from the housing 106 by an encapsulating layer of thermal insulation having an R-value of at least 1. As such, the housing 106 includes outer and inner layers of metallic material, both of which are generally prismatic in shape, with the thermal insulation disposed therebetween to be sandwiched between the layers. The outer layer of the housing is collectively formed by an outer layer or skin of the container 209 and an outer skin or layer of the lid; the inner layer of the housing is collectively formed by an inner layer or skin 211 of the container and an inner layer or skin of the lid 403; and the thermal insulation is collectively formed by thermal insulation 210 received between the outer and inner layers of the container and thermal insulation 402 received between the outer and inner layers of the lid.

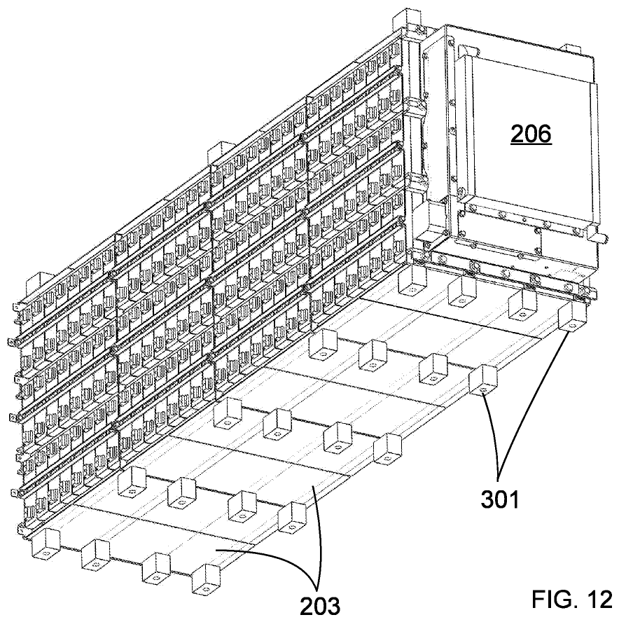

FIG. 12 shows the bottom of the battery pack 201 with the outer layer and insulation removed. The weight of the battery pack is held up by a material of low thermal conductivity and high compressive strength such as ABS to minimize thermal bridging with the outside environment. In the illustrated embodiment, rectangular blocks 301 of the same thickness as the insulation are shown even though they can be round for ease of manufacturing. They are shown directly underneath the intersection of the tension bars 202 with the columns 203 but may be located elsewhere in other arrangements of battery pack. Additional blocks 301 may be used on the top as well as the bottom to increase rigidity. In the illustrated embodiment, 20 blocks 301 are used on the bottom, and 6 on the top, however different quantities of blocks may be used based on design requirements. It will be appreciated that the blocks 301 may be of any form factor, that is any three-dimensional shape.

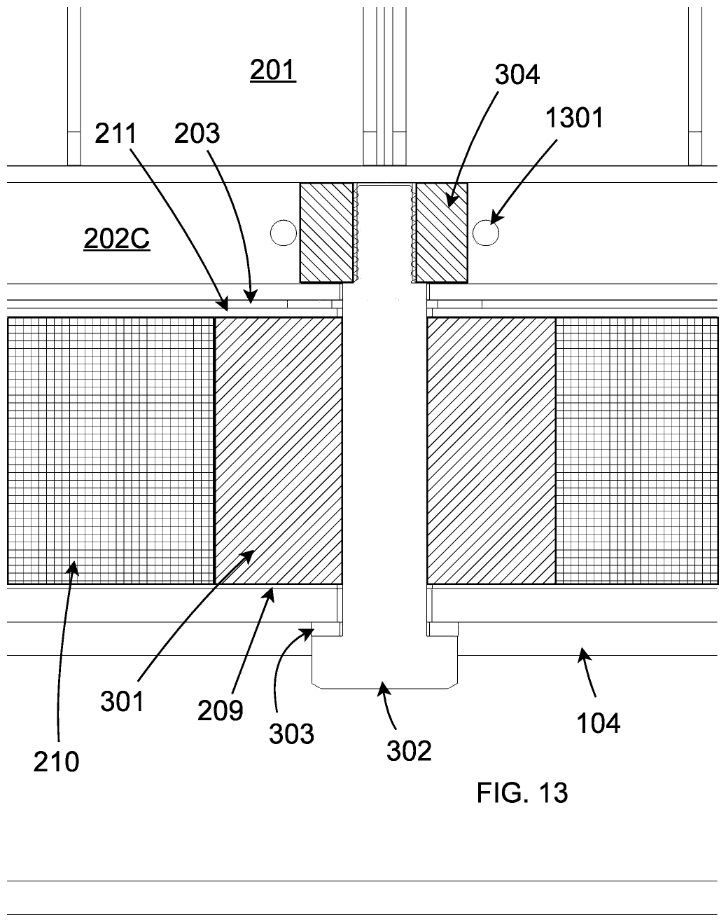

FIG. 13 illustrates a mechanism to fasten the battery pack 101 to a bracket 104 on a vehicle 102. In the illustrated embodiment, a shoulder bolt 302 with a washer 303 is torqued onto a threaded steel insert 304, with the exterior mounting bracket 104, enclosure outer layer 209, block 301, enclosure inner layer 211, column 203, and tension bar 202 in between. A shoulder bolt 302 is used so the shoulder can torque against the steel insert 304 predictably and controllably, rather than compressing and possibly damaging the other components. The threaded steel insert 304 may be integrated into the threaded steel insert 901 for those that are located at the ends. If the mounting location is not at one of the ends, the insert 304 can be a bar possibly located with blind rivets. If the tension bar 202 is a solid bar, it can simply be drilled and threaded with no inserts. However, a hollow tube is preferred to save weight and material. The insulation 210 fills the space between blocks 901 in axial, depth, and height directions of the container 107.

In other words, outermost ones of the rails in the array, which are closest or in proximal relation to walls of the container, and indicated at 202C, are fastened to the external mounting bracket 104 through the container 107 to support the array of the rails 202 in fixed relation to the container. More specifically, lower and upper ones of the outermost rails in the array, which are closest to upper and lower walls of the container, are fastened to the external mounting brackets.

The outermost rails of the array are supported in spaced relation to the container by thermally insulating bodies 301 configured to receive substantially thermally nonconductive fasteners 302 interconnecting the outermost rails 202C and the external mounting bracket 104. The fasteners are substantially thermally nonconductive in that the fasteners provide no or negligible conduction of heat. This is achieved by a constituent material from which the fasteners are made.

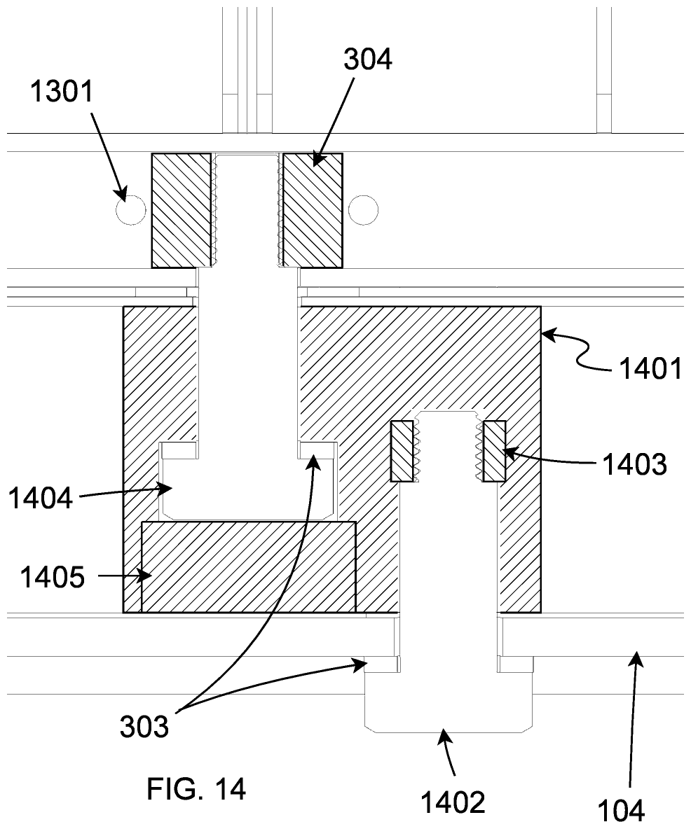

The section view in FIG. 14 illustrates an alternate block configuration. The section view is of the insulating block 1401, which for this new configuration is used in place of insulating block 301. This configuration is designed to further reduce thermal bridging. In this case the exterior mounting bolts 1402 pass only part way through the insulating blocks 1401 and are fastened with a nut or threaded insert 1403 inside the block 1401 material. These should be shoulder bolts or else have steel sleeves so they can properly torque onto insert 1403. An additional bolt 1404, which is offset from bolt 1402, is used to fasten the block 1401 to the interior structure to threaded insert 304 in the same way as in the previously described embodiment. The hole in the bottom where bolt 1404 is inserted may accommodate a plug 1405 of the same material as the insulating block 1401. In this configuration there are no bolts penetrating all the way through the insulating layer, so thermal bridging is reduced. However, this configuration is also more complex and relies more on the structure of the insulating block material. One skilled in the art can determine the appropriate configuration for one's application.

In other words, distinct substantially thermally nonconductive fasteners are carried in the thermally insulating bodies 1401 and in longitudinally spaced relation to each other for interconnecting the outermost rails 202C and the external mounting bracket including a first set of the fasteners 1402 configured to interconnect the external mounting bracket 104 and the thermally insulating bodies and a second set of the fasteners 1404 configured to interconnect the thermally insulating bodies and the outermost rails.

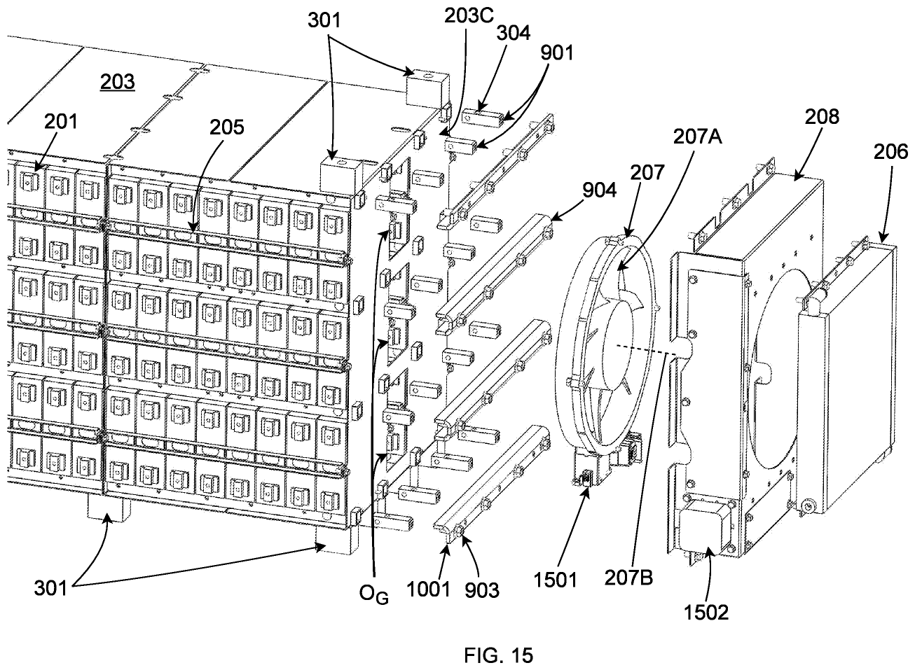

FIG. 15 shows an exploded view of the front section of the battery pack 201. In the illustrated embodiment, the shroud 208 houses the fan 207 and some electrical components including relays 1501 and the manual service disconnect 1502. Other configurations are possible including mounting such components elsewhere. One will notice that the threaded inserts 601 are not all the same length because those that are located in-line with an exterior fastening bolt 302 and block 301 are integrated with threaded insert 304 in the illustrated embodiment.

It will be appreciated that the specific embodiments described above and illustrated in the figures represent a subset of all possible forms. One skilled in the relevant art will recognize the invention may adapt to different specific forms to fit a different geometry or application or the constraints of a particular project, while still falling withing the characteristics of the invention.

In other words, the scope of the claims should not be limited by the preferred embodiments set forth in the examples but should be given the broadest interpretation consistent with the specification as a whole.

1. A battery pack for providing a prescribed voltage comprising:
a plurality of battery cells respectively configured to provide cell voltages and electrically interconnected to form the prescribed voltage of the battery pack;
a housing comprising a container defining an interior configured to receive the battery cells, wherein the container comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction, wherein the housing is configured to permit passage of the battery cells through the container for transferring the battery cells between an exterior of the housing and the interior;
an array of rails in the container, wherein the rails respectively extend longitudinally of the container between opposite ends of the rails, wherein the rails are arranged in spaced parallel relation to each other, wherein the array comprises plural pairs of the rails in which respective ones of the pairs of the rails are spaced apart in the second transverse direction by a distance substantially equal to a dimension of a respective one of the battery cells in the second transverse direction, so as to form longitudinally-extending slots for receiving the battery cells in plural longitudinally-extending rows, wherein the array of the rails is supported in fixed relation to the container;
a plurality of upstanding planar panels respectively oriented substantially normal to the longitudinal axis and arranged at longitudinally spaced positions in the container, wherein the panels are configured to support the array of the rails passing therethrough, wherein a first endmost one of the panels is at or adjacent first ones of the opposite ends of the rails and a second endmost one of the panels is at or adjacent second ones of the opposite ends of the rails and wherein the endmost panels delimit therebetween, in the longitudinal direction, a battery-receiving volume in the interior within which the battery cells are received in the rows;
a plurality of spacers supported between each adjacent pair of the battery cells in a common one of the rows to maintain adjacent ones of the battery cells in the common row in longitudinally spaced relation to each other;
wherein the panels and the spacers are slidably supported on the rails so as to be freely movable relative thereto along the longitudinal axis; and
pairs of stoppers respectively supported on the rails outwardly of the endmost panels relative to the battery-receiving volume and configured for butting engagement with the endmost panels for applying compressive force on the rows of the battery cells to maintain the battery cells in fixed location within the container.

2. The battery pack of claim 1 wherein, when the array includes a plurality of the slots in the second transverse direction of the container, the spacers include an intervening set of the spacers disposed between adjacent ones of the rails of each adjacent pair of the slots relative to the second transverse direction so as to bridge between the adjacent slots relative to the second transverse direction.

3. The battery pack of claim 1 wherein first ones of the pairs of stoppers are affixed to respective ones of the rails and second ones of the pairs of stoppers are longitudinally movable relative to the respective rails.

4. The battery pack of claim 3 wherein sets of the second ones of the pairs of stoppers, which are adjacent in a crosswise direction to the longitudinal axis, are interconnected to uniformly apply force in said crosswise direction across the second endmost panel.

5. The battery pack of claim 1 further including longitudinally-extending retaining brackets supported outwardly of the rows of the battery cells and intermediate respective ones of each pair of the rails forming the slots relative to the second transverse direction, wherein the retaining brackets are configured for butting engagement with peripheries of the battery cells in the rows to resist movement in the first transverse direction.

6. The battery pack of claim 1 wherein, when the array of the rails includes a plurality of the slots in the first transverse direction and in the second transverse direction of the container, adjacent ones of the rows of the battery cells relative to the first transverse direction are uniformly spaced apart by a first distance greater than a second distance between adjacent ones of the rows relative to the second transverse direction.

7. The battery pack of claim 1 wherein, when the array of the rails includes a plurality of the slots in the first transverse direction and in the second transverse direction of the container and when the housing is breathably fluidically sealed and contains a gaseous heat transfer medium, the battery pack further includes a thermal fluid conditioning unit configured to (i) circulate the heat transfer medium in the housing and adapted to convey heat and (ii) regulate a temperature of the battery cells, wherein the thermal fluid conditioning unit comprises:
a fan in the container and located outwardly of the battery-receiving volume at or adjacent the second ends of the rails, wherein the fan comprises a plurality of blades rotatable around a rotational axis oriented parallel to the longitudinal axis of the housing and centered relative to the array of rails, wherein the fan is configured to generate a flow of the heat transfer medium within the container in which the heat transfer medium moves from a second one of the ends of the container, proximal to the second ends of the rails, and along a periphery of the container towards a first one of the ends of the container proximal to the first ends of the rails, inwardly towards a central longitudinally-extending portion of the battery-receiving volume and subsequently towards the second end of the container, and
a heat exchanger in the container and arranged in series with the fan, wherein the heat exchanger is configured to add or extract heat from the gaseous heat transfer medium.

8. The battery pack of claim 7 wherein the heat exchanger is disposed downstream from the fan relative to the flow of the heat transfer medium in the housing.

9. The battery pack of claim 7 wherein the thermal fluid conditioning unit is supported in fixed relation to the array of the rails by the second ones of the pairs of stoppers.

10. The battery pack of claim 1 wherein, when the spacers have thicknesses measured in the longitudinal direction for providing the spaced relation of the adjacent battery cells, the thicknesses of the spacers are in a range from 1 mm to 5 mm.

11. The battery pack of claim 1 wherein the battery-receiving volume is thermally insulated from the housing by an encapsulating layer of thermal insulation having an R-value of at least one.

12. The battery pack of claim 1, in combination with a mounting bracket external to the housing, wherein outermost ones of the rails in the array, which are closest to walls of the container, are fastened to the external mounting bracket through the container to support the array of the rails in fixed relation to the container.

13. The battery pack of claim 12 wherein the outermost rails of the array are supported in spaced relation to the container by thermally insulating bodies configured to receive substantially thermally nonconductive fasteners interconnecting the outermost rails and the external mounting bracket.

14. The battery pack of claim 13 wherein distinct substantially thermally nonconductive fasteners are carried in the thermally insulating bodies and in longitudinally spaced relation to each other for interconnecting the outermost rails and the external mounting bracket including a first set of the fasteners configured to interconnect the external mounting bracket and the thermally insulating bodies and a second set of the fasteners configured to interconnect the thermally insulating bodies and the outermost rails.

15. The battery pack of claim 1 wherein, when the battery cells are prismatic in shape and have outer surfaces each having an opposite pair of large faces spaced apart in a first dimension of the battery cell and substantially normally oriented to the longitudinal direction, an opposite pair of first narrow faces spaced apart in a second dimension crosswise to the first dimension and substantially normally oriented to the first transverse direction and an opposite pair of second narrow faces spaced apart in a third dimension crosswise to both the first and second dimensions of the battery cell and substantially normally oriented to the second transverse direction, wherein the first dimension is smaller than the second and third dimensions; and when end portions of the large faces of the battery cells defining portions of peripheral edges thereof are resiliently compressible in a direction along the first dimension, the spacers are arranged for butting engagement with the end portions of the large faces of the battery cells such that the battery cells are resiliently compressed upon application of the compressive force by the stoppers.

16. A battery pack for providing a prescribed voltage comprising:
a plurality of battery cells respectively configured to provide cell voltages and electrically interconnected to form the prescribed voltage of the battery pack;
a housing defining an interior configured to receive the battery cells, wherein the housing comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction;
wherein the battery cells are arranged in an array of plural longitudinally-extending rows arranged side-by-side in both the first and second transverse directions;
wherein the battery cells of each row are in spaced relation to each other;
wherein the rows of the battery cells are in spaced relation to each other and to the housing so as to form a peripheral gap;
wherein the housing is breathably fluidically sealed and contains a gaseous heat transfer medium; and
a thermal fluid conditioning unit configured to (i) circulate the heat transfer medium in the housing and adapted to convey heat and (ii) regulate a temperature of the battery cells, wherein the thermal fluid conditioning unit comprises:
a fan located in the peripheral gap of the housing and generally at a first one of the ends of the housing, wherein the fan comprises a plurality of blades rotatable around a rotational axis oriented parallel to the longitudinal axis of the housing and centered relative to the array of the battery cells, wherein the fan is configured to generate a flow of the heat transfer medium within the container in which the heat transfer medium moves from the first end of the housing and along a periphery of the container towards a second one of the ends of the housing distal to the fan, inwardly towards a central longitudinally-extending portion of the array of the battery cells and subsequently towards the first end of the housing; and
a heat exchanger in the container and arranged in series with the fan, wherein the heat exchanger is configured to add or extract heat from the gaseous heat transfer medium.

17. The battery pack of claim 16 wherein the heat exchanger is disposed downstream from the fan relative to the flow of the heat transfer medium in the housing.

18. The battery pack of claim 16 wherein spacing between adjacent ones of the battery cells of a common one of the rows ranges from 1 mm to 5 mm.

19. A battery pack for providing a prescribed voltage, in combination with an external mounting bracket, comprising:
a plurality of battery cells respectively configured to provide cell voltages and electrically interconnected to form the prescribed voltage of the battery pack;
a housing defining an interior configured to receive the battery cells, wherein the container comprises opposite ends spaced apart along a longitudinal axis, a first pair of opposite sides spaced apart in a first transverse direction crosswise to the longitudinal axis and a second pair of opposite sides spaced apart in a second transverse direction crosswise to both the longitudinal axis and the first transverse direction;
an array of rails in the container, wherein the rails respectively extend longitudinally of the container between opposite ends of the rails, wherein the rails are arranged in spaced parallel relation to each other, wherein the array comprises plural pairs of the rails in which respective ones of the pairs of the rails are spaced apart in the second transverse direction by a distance substantially equal to a dimension of a respective one of the battery cells in the second transverse direction, so as to form longitudinally-extending slots for receiving the battery cells in plural longitudinally-extending rows, wherein the array of the rails is supported in fixed relation to the container;
a plurality of upstanding planar panels respectively oriented substantially normal to the longitudinal axis and arranged at longitudinally spaced positions in the container, wherein the panels are configured to support the array of the rails passing therethrough, wherein a first endmost one of the panels is at or adjacent first ones of the opposite ends of the rails and a second endmost one of the panels is at or adjacent second ones of the opposite ends of the rails and wherein the endmost panels delimit therebetween, in the longitudinal direction, a battery-receiving volume in the interior within which the battery cells are received in the rows;
wherein the panels are supported on the rails so as to be detached from the housing;
wherein the endmost panels are arranged to be urged towards each other to apply compressive force on the rows of the battery cells to maintain the battery cells in fixed location within the container; and
wherein outermost ones of the rails in the array, which are closest to walls of the container, are fastened to the external mounting bracket through the container to support the array of the rails in fixed relation to the container.

20. The battery pack of claim 19 wherein the outermost rails of the array are supported in spaced relation to the container by thermally insulating bodies configured to receive substantially thermally nonconductive fasteners interconnecting the outermost rails and the external mounting bracket.

21. The battery pack of claim 19 wherein distinct substantially thermally nonconductive fasteners are carried in the thermally insulating bodies and in longitudinally spaced relation to each other for interconnecting the outermost rails and the external mounting bracket including a first set of the fasteners configured to interconnect the external mounting bracket and the thermally insulating bodies and a second set of the fasteners configured to interconnect the thermally insulating bodies and the outermost rails.

22. The battery pack of claim 19 wherein the battery-receiving volume is thermally insulated from the container by an encapsulating layer of thermal insulation having an R-value of at least one.
